(19) United States
(12) Patent Application Publication
(10) Pub. No.: US 2016/0301495 A1
(43) Pub. Date: Oct. 13, 2016

(54) Power Efficient Multi-Degree ROADM Using Variable Optical Splitter

(71) Applicant: NEC Laboratories America, Inc., Princeton, NJ (US)

(72) Inventors: Philip Nan Ji, Cranbury, NJ (US); Ting Wang, West Windsor, NJ (US); Yoshiaki Aono, Tokyo (JP)

(21) Appl. No.: 15/089,699

(22) Filed: Apr. 4, 2016

Related U.S. Application Data
(60) Provisional application No. 62/144,583, filed on Apr. 8, 2015.

(51) Int. Cl. H04J 14/02

(52) U.S. Cl. CPC H04J 14/021

(57) ABSTRACT

A reconfigurable optical add/drop multiplexer (ROADM) system includes a transponder aggregator section with one or more transponder aggregators; N input ports and N output ports, each coupled to the transponder aggregators and to a cross-connect module having a variable optical splitter or variable optical coupler (VOS/VOC); and a controller to set the VOS/VOC into one of a Multicast & Select configuration and a Route & Combine configuration.

This application claims priority to Provisional Application 62/144,583 filed Apr. 8, 2015, the content of which is incorporated by reference.

### BACKGROUND

The present invention relates to a power efficient ROADM system.

Multi-degree reconfigurable optical add/drop multiplexer (MD-ROADM) is a key element in the current DWDM network. Sometimes it is also called a wavelength cross-connect (WXC). It provides per-wavelength level switch functions in a multi-degree node, the functions include: cross-connection of WDM signals among different paths, adding and/or dropping of any or all WDM channels from/to local transponders, per wavelength attenuation, and power monitoring, etc. FIG. 1 illustrates some basic switching functions of an N degree ROADM node.

Besides these features, the current MD-ROADM needs to provide colorless and directionless features. The colorless feature means that each add/drop port is not associated with a fixed wavelength, but can handle any WDM channel with the operation wavelength range. The directionless feature means that each transponder can receive WDM signal dropped from any input degree, and can add the WDM signal to any output degree. Other desirable features include contentionless (which means that the WDM channels with the same wavelength from multiple degrees can be added and/or dropped simultaneously), gridless (which means that the WDM channels does not need to have the same pre-determined grid such as 50 GHz or 100 GHz, but can have non-uniform grids that can be reconfigured dynamically according to network requirement), filterless (which means that there is no need for a wavelength selector hardware, such as tunable filter or wavelength-selective switch, at each transponder input), and gapless (which means that multiple WDM channels can be switched together as a waveband).

In order to achieve the MD-ROADM functions and the colorless and directionless (CD) features, most of the latest MD-ROADMs use a 2-section structure (FIG. 2). The cross-connect section contains N cross-connect modules, one for each degree. The transponder aggregator section process the add/drop request between the input/output and the local transponders, and can contain one or more sub-modules. It enables colorless and directionless operation, as well as other optional features such as contentionless add/drop. This modular structure allows the node to be configured according to the need (such as number of degrees and amount of add/drop) and allows easy upgrade. There are different node architectures based on this 2-section structure, and there are different transponder aggregator designs.

At the input of each cross-connect module, the input signal is sent to different destinations, including the node output ports (for through or cross-connect operation) and the transponder aggregator input ports (for add/drop operation). And the output, signals from different sources are combined, including the through and cross-connect signals from different input degrees, and the added signals from the transponder aggregator. The optical components used at the input and output ends of the cross-connect module are usually WDM demultiplexer, WDM multiplexer, optical coupler, optical splitter, or wavelength-selective switch (WSS). But since regular WDM multiplexer and demultiplexer are passive device and cannot support colorless and directionless feature easily with this architecture, the latest ROADM nodes usually do not use them. Therefore the cross-connect module usually have one of the 3 configurations:

(1) 1xM WSS at the input, and M:1 optical coupler at the output (it can be called Route & Combine configuration.)

(2) 1:M optical splitter at the input, and Mx1 WSS at the output (it can be called Broadcast & Select configuration.)

(3) 1xM WSS at the input and M×1 WSS at the output (it can be called Route & Select configuration.)

Here the port count M is the sum of cross-connect paths (N or N−1 for an N-degree node, depending on whether loopback is required) and the drop/add paths to/from the transponder aggregator (T, where T≧1). M=9 is a common setting for now, as most of the MD-ROADM nodes are up to 8 degrees. However, the continuous growth of 40% per year in network traffic will yield 10 times more traffic in seven years and 100 times in fourteen years. The explosion in traffic forces an increase in the number of wavelength paths and hence fibers between adjacent nodes [3]. Therefore, large-port-count MD-ROADM has been proposed and researched. For example, a 64×64 MD-ROADM prototype has been developed with throughput up to 204.8 Tb/s, and has been verified by transmission experiments (even though it is called Optical Cross-Connect or OXC in this reference, it is the same as MD-ROADM.

Therefore, the cross-connect module contains only two main types of optical components, namely the WSS and the optical coupler/splitter (a x:1 optical coupler and a 1:x optical splitter are essentially the same device, the only difference is the direction of signal during operation, therefore in the remaining of this document, the terms optical coupler and optical splitter are used interchangeably, each of them can represent both coupler and splitter). Between them, WSS is must more costly since it is a highly integrated device, which consists of wavelength separator, wavelength combiner, an array of 1×N optical switches, and possibly optical power monitors, etc. Since it is actively controlled and has large number of elements to be controlled, it also requires complicated electronic circuitry for switch control, temperature control, memory, communication with system management, etc. And it requires electrical power supply and control and communication media too. Overall the cost, size, power consumption of a WSS are much higher than an optical coupler/splitter with the same port count. Therefore it is desirable to use one WSS with one coupler or splitter (i.e. Route & Combine configuration or Broadcast & Select configuration), instead of using WSS at both input and output ends (i.e. the Route & Select configuration).

However, unlike WSS where the device insertion loss is similar as the port count increases (maybe only slight increase due to the increased difficulty of optical path requirement for higher port device), the insertion loss in optical splitter increases with the number of ports, since the same amount of input optical power is split among more outputs. Therefore it is not suitable to be used in higher power count MD-ROADM, unless optical amplifiers are used. This requires large number of optical amplifiers (since each port requires one amplifier), and high power consumption.

Thus, conventional systems: (1) use optical amplifiers (which requires high power consumption, besides the hardware cost), or (2) use Route & Select configuration (which requires twice the amount of WSS, therefore is costly, and requires more space, control complexity, and power consumption).

### SUMMARY

In one aspect, a reconfigurable optical add/drop multiplexer (ROADM) system includes a transponder aggregator; N input ports and N output ports, each coupled the transponder aggregator and to a cross-connect module having a variable optical splitter or variable optical coupler (VOS/VOC); and a controller to set the VOS/VOC into one of a Multicast & Select configuration and a Route & Combine configuration.

In another aspect, a variable optical splitter is used to replace the regular optical splitter/coupler. Since most of the time, only partial splitter/coupler ports are used to carry useful data, the variable optical splitter allows the port count and the splitting ratio to be set to the exact required setting, therefore reduces unnecessary power loss and maximizes power efficiency.

Advantages of the system may include one or more of the following. The system increases the power efficiency (i.e. reduce unnecessary power waste) in MD-ROADM. The system will reduce the power consumption of the overall MD-ROADM system, and thus reduce the operation cost of the WDM network. It also enables higher port count switching node, and can support more upcoming applications that require high port count system.

### BRIEF DESCRIPTION OF THE DRAWINGS

FIG. 1 shows exemplary switching functions of an N degree ROADM node.

FIG. 2 shows exemplary structure of an N degree CD ROADM.

FIG. 3 shows examples of variable optical splitters.

FIG. 4 shows exemplary VOS-based Power efficient MD-ROADM in Broadcast & Select (Multicast & Select) configuration.

FIG. 5 shows examples of optical splitter operation: (a) Conventional fixed splitter, (b)-(d) VOS.

FIG. 6 shows examples of VOS-based Power efficient MD-ROADM in Route & Combine configuration

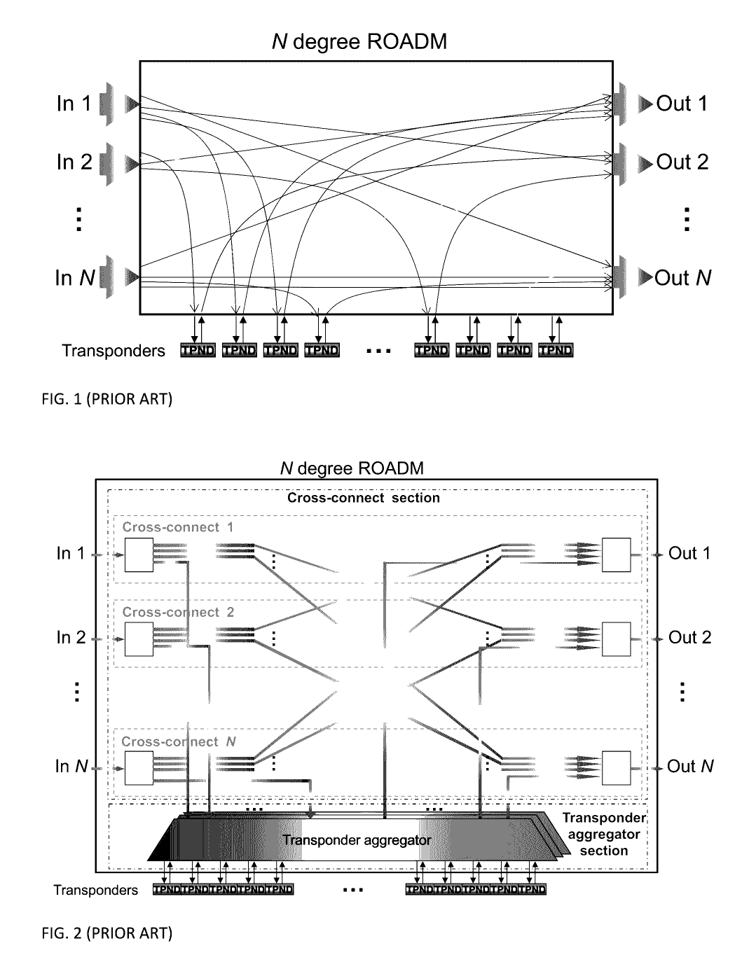

### DESCRIPTION

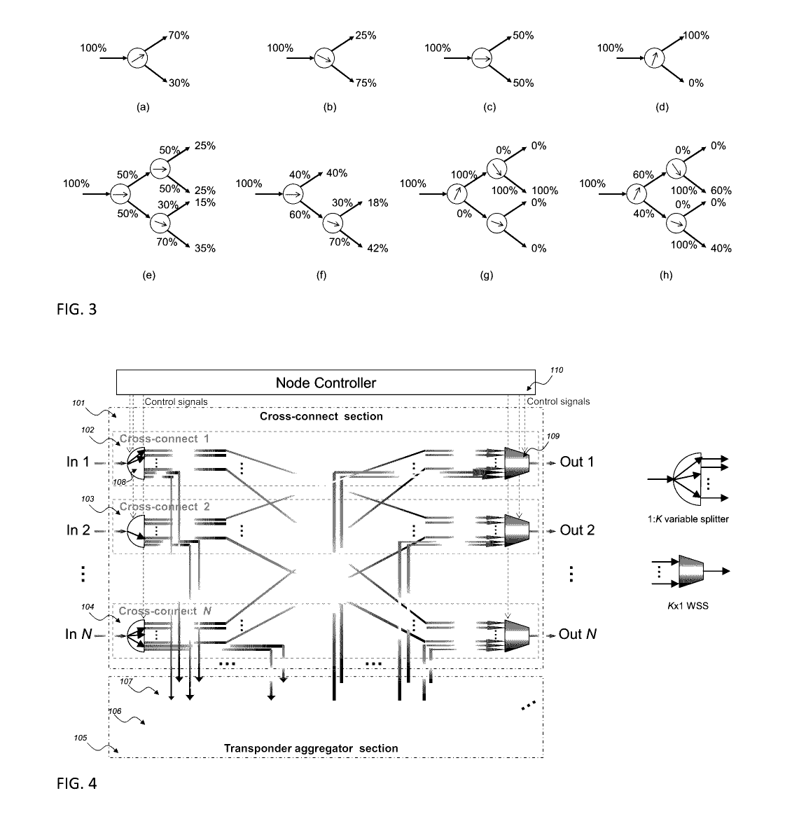

FIG. 3 shows examples of variable optical splitters of exemplary MD-ROADM architecture. An optical splitter is a passive device that splits (i.e. broadcasts) the incoming optical signal into two or multiple (K) parts, each carrying the same signal (i.e., not wavelength-specific, unlike optical filter or WSS) but with lower power. This is a very common and simple component in optical system. In most cases, each output has the same splitting ratio (such as 50% at each output in a 1:2 splitter, or 33% at each output in a 1:3 splitter). However, an asymmetric splitting ratio can also be set (such as 70%:30% in a 1:2 splitter, or 50%:20%:30% in a 1:3 splitter). The splitting leads to insertion loss of the signal (such as 3 dB loss for 50% splitting). Regardless of being equal or asymmetric, the splitting ratio is preset during manufacturing of the splitter, and cannot be changed once the component is made. If used in the reverse direction, it is called optical coupler, which combines two or more optical signals into a single output. The same insertion loss is experienced no matter the component is used as splitter or coupler. Since they are the same device, it is common that the terms “splitter” and “coupler” are used interchangeably.

A 1:K variable optical splitter (VOS) is one that allows the dynamic variation of the splitting ratio among the K outputs. The basic configuration is a 1:2 variable optical splitter, where the splitting ratio between the 2 output ports can be adjusted dynamically, as illustrated in FIGS. 3(a)-3(d). The splitting ratios include symmetric (50%:50%) or asymmetric (such as 70%:30% or 25%:75%). In the extreme case of 100%:0% splitting ratio, all the signal are sent to one output, making it essentially behaving like a 1×2 switch (FIG. 3(d)). Multiple of such VOS can be cascaded to form VOS with higher port count. FIG. 3(e) is an example of adding two 1:2 VOS's to the two output of the first VOS, therefore it functions as a 1:4 VOS. The splitting ratio at each sub-VOS can be adjusted dynamically and independently, therefore the splitting ratio among the four output ports can also be adjusted dynamically. Such cascading can produce 1:2^{P} VOS with 2^{P} output ports, where P is an integer. If the required output port is not a power of 2, some branch VOS can be removed, such as the 1:3 VOS example shown in FIG. 3(f).

As in 1:2 VOS described above, a 1:K VOS with K outputs can also be configured to act as a 1×K switch, as illustrated in the 1×4 switch example in FIG. 3(g), where the input light is switched to output port 2. It can also be configured as 1×K multicasting switch, as shown in FIG. 3(h), where the input light is multicast to only output port 2 and output port 4, with asymmetric power ratios.

Therefore, a 1:K VOS can act as 1×K single output switch, or 1×k (k≦K) multicasting switch, or 1:K regular symmetric splitter, or 1:K splitter with any splitting ratio. These configurations can be changed dynamically through electronic control. The total optical power from all output ports equals the input power (minus the additional loss due to connection interface or manufacturing quality, which is usually a small amount). Such device can be used in reverse direction to function as K×1 regular optical switch, or k×1 (k≦K) multicasting combiner, or K:1 regular symmetric coupler, or K:1 coupler with any coupling ratio. Since they are essentially the same device, the term “variable optical splitter (VOS)” refers to both variable optical splitter and variable optical coupler in the remaining of this document.

Variable optical splitter can be made from sliding prisms, rotating hemi-cylinders, changing the coupling region length of the fiber coupler, changing the refractive index of the two outputs in a Y-junction waveguide, changing polarization state of beam by wave plate rotation, manually adjusting slot waveguide, adjusting applied voltage in an electro-optic interferometer, changing fiber alignment to a double spot-size mode converter, etc. Among them, some technologies are based on photonic integrated circuits and allow high number of sub-VOS components to be integrated in a compact size and with little additional loss.

VOS has been applied in a multicasting switch (MCS) to mitigate contention in a colorless, directionless ROADM (reconfigurable optical add/drop multiplexer). VOS can also be used in the subcarrier aggregator at the transmitter end of a super-channel transceiver, as well as in the subcarrier combiner at the receiver end of a super-channel transceiver [9]. The benefit is to reduce the power waste and increase power efficiency. Here, we use the VOS in the cross-connect section of the MD-ROADM to optimize the power efficiency.

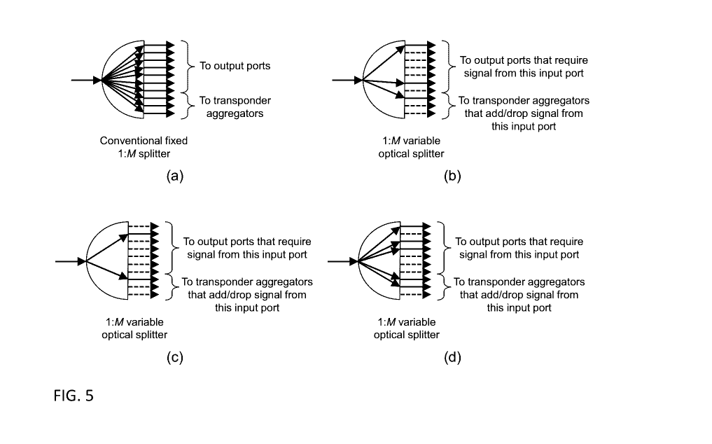

Next, a Power efficient MD-ROADM with Broadcast & Select configuration is detailed. FIG. 4 shows exemplary VOS-based Power efficient MD-ROADM in Broadcast & Select (Multicast & Select) configuration, while FIG. 5 shows examples of optical splitter operation: (a) Conventional fixed splitter, (b)-(d) VOS. FIG. 4 shows the application of VOS in MD-ROADM's cross-connect section with Broadcast & Select configuration. The node has N degree, which means that it has N inputs and N outputs (not including add/drop ports). Therefore its cross-connect section (101) contains N cross-connect modules (such as 102 to 104), and is connected to transponder aggregation section (105), which contains T transponder aggregators (such as 106 to 107).

Each degree has a cross-connect module (such as 102 to 104). At the input side of the cross-connect module, a 1:M variable optical splitter is placed (such as 108 for cross-connect 1 102). Here M equals to N+T when loopback path is provided, or equals to N+T−1 when loopback path is not provided. The 1:M VOS has M output fibers, and are connected to the N output ports (except the one corresponding to the same input, if loopback path is not set up) and the T transponder aggregators respectively through fiber connections. At each output port, an M×1 WSS (such as 109 for cross-connect module 1) is placed to receive the signals from different cross-connect modules and the transponder aggregators. The connection among the cross-connect modules and the transponder aggregators are the same as in conventional MD-ROADM.

However, since the regular 1:M splitter is replaced by the 1:M VOS, the power splitting arrangement in this ROADM is different than the conventional ROADM. In conventional ROADM, each output of the 1:M splitter has at most 1/M of the input power, regardless of the channel arrangement and signal routing status. But in the instant ROADM, the input power is not split to all output fiber ports, instead only to those ports (including ROADM output ports and transponder aggregator ports) that some or all of the input channels need to be sent to. For example, if the ROADM has a degree of 8, and has 3 transponder aggregators, each input splitter will be a 1:10 splitter (8+3−1, assuming no loopback paths), as shown in FIG. 5(a). Therefore the splitter will introduce 10 dB insertion loss. This is a theoretical value, in reality it is typically about 12 dB. If fiber connector loss is added, the loss is even higher.

In most of the network operation, the WDM signal from one input fiber usually travels to only a few output ports simultaneously, the number is much less than the total port count. Also, in the CD MD-ROADM, usually the add/drop channels are processed in the first transponder aggregator first. When all the add/drop ports in the first transponder aggregator are occupied, the second transponder aggregator will be used to process the new add/drop channels, and so on. Therefore it is rare that all the transponder aggregators will be used simultaneously. Typically only a small number of them are used. Therefore the total number of ports that require the input signal is much less than M. For conventional MD-ROADM with regular fixed optical splitter, the splitting ratio cannot be adjusted according to the actual required output number. But with the VOS, the splitting ratio can be flexibly adjusted accordingly.

For example, assuming that the input signals from Port 1 of the MD-ROADM contains 80 WDM channels. Among them, Channels 1-10 and Channels 16-30 need to go to output Port 2 (corresponding to the first output of the optical splitter), Channels 34-80 need to go to output Port 7 (corresponding to the sixth output of the optical splitter), and the remaining 8 channels (namely Channels 11-15 and Channels 31-33) need to be dropped at this MD-ROADM node. And assuming that each transponder aggregator have 48 add/drop ports, and at the moment only 20 add/drop port in the Transponder Aggregator 1 are occupied. Therefore all the 8 add/drop channels from Input 1 can also be accommodated at the Transponder Aggregator 1. Therefore the input signals from Port 1 only need to be switched to 3 destinations, namely Output 2, Output 7, and Transponder Aggregator 1. The corresponding outputs on the optical splitter are the first, the sixth, and the eighth outputs. With the knowledge of this network setting, the node controller (110 on FIG. 4) configures the VOS to be a 1:3 splitter, which splits the input signal among these 3 outputs only, as shown on FIG. 5(b). Therefore the theoretical insertion loss if only 4.77 dB, and the typical insertion loss is about 5.5 dB. This is significantly lower than the conventional splitter.

In another example, as shown in FIG. 5(c), if the input signals only need to be switched to output Port 3 and Transponder Aggregator 1, the VOS is configured to become 1:2 splitter, and the insertion loss is only 3 dB (theoretical) or 3.3 dB (typical).

In another example, as shown in FIG. 5(d), if the input signals only need to be switched to more ports, including output Ports 2, 4 and 5, and Transponder Aggregators 1 and 2, the VOS is configured to become 1:5 splitter, and the insertion loss is 7 dB (theoretical) or 8.5 dB (typical), which is still lower than the conventional fixed splitter.

If the number of node degree increases in the future, as forecast in scientific publications, the reduction in insertion loss levels by the power efficient VOS-based ROADM will be even greater. For example, a 64×64 node with 16 transponder aggregator will face more than 19 dB theoretical insertion loss at the splitter alone (and the actual insertion loss will be at least a few dB higher). But if each input's signals only go to a few output ports, the VOS-based ROADM can maintain the insertion loss at the similar levels as the examples above.

With the flexible reconfiguration capability offered by VOS, the Broadcast & Select node configuration becomes more like a Multicast & Select configuration, since the input signals only go to the appropriate outputs. This reduces the waste of optical power, and reduces the amplification requirement in the WDM network, thus optimizes the power efficiency.

This architecture allows multicasting of input signals, since each input WDM channel can be received at all the output ports that the VOS's active output ports are connected to, as long as the corresponding WSS accepts this channel. This is the same as the conventional fixed optical splitter-based Broadcast & Select architecture, but here the multicasting is more selective and controllable.

Besides power efficiency optimization, the use of VOS also reduces signal crosstalk from unwanted inputs, because it does not send unnecessary input ports' signal to the output. This helps to improve the signal quality in the network.

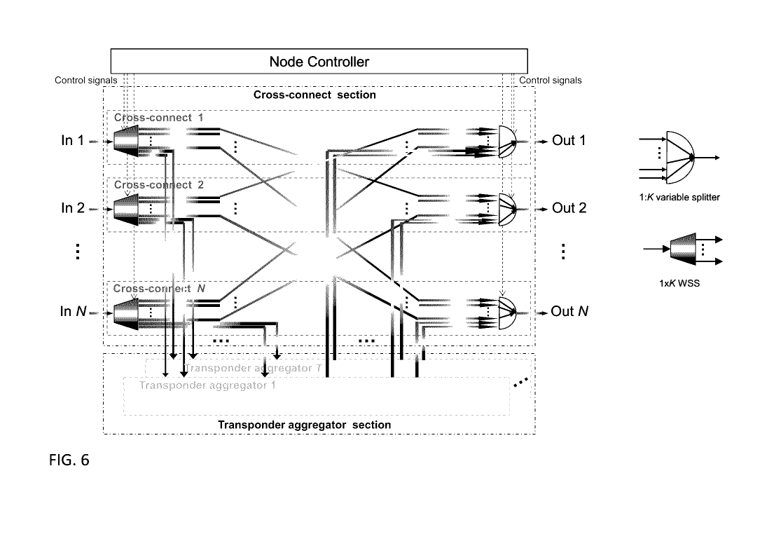

Next, a power efficient MD-ROADM with Route & Combine configuration is detailed. For the Route & Combine configuration, the instant node setup and connection is similar to the conventional one, except that the M:1 optical coupler at each cross-connect module's output side is replaced with a M:1 VOC (variable optical coupler, essentially the same as VOS), as shown in FIG. 6.

The WSS at the input of each cross-connect module separates the input WDM signals and sends them to the appropriate outputs (including the N or N−1 ROADM outputs, or the T transponder aggregators). The operation of the VOS is similar to the VOS in the Multicast & Select configuration described above. The VOS at the output of each cross-connect module combines the cross-connect signals from different WSS's and the added signals from the transponder aggregators. Since most likely only some of the total input fiber contains actual signal (say m), the VOS is configured to be a m:1 coupler, instead of a M:1 coupler as in conventional fixed coupler-based node. Since m≦M, the insertion loss of the VOS is smaller than the conventional node, and thus the power efficiency is optimized. FIG. 6 shows examples of VOS-based Power efficient MD-ROADM in Route & Combine configuration

Unlike the Multicast & Select architecture above, the Route & Combine architecture does not support multicasting, unless multicast-capable WSS's are used (current commercial WSS products do not support multicasting function).

The crosstalk-prevention feature due to VOS is also available in the Route & Combine configuration.

As discussed earlier, the VOS allows flexible setting of the splitting ratio, therefore the power levels at different outputs of the VOS do not need to be the same. They can be set according to the network requirements. For example, if the add/drop channels require more power, larger splitting ratio can be set for the particular VOS output port(s). If the through or cross-connect channels require more power, larger splitting ratio can be set for the corresponding VOS output port(s). This will also help to balance the signal from different input ports arriving at the same output port (of course, the WSS at the output port can also be used to balance the power).

In order to optimize the power level through the VOS, besides using the information of the number of “useful” ports, the controller can also take the live power level values obtained by internal or external optical power monitoring system or optical power meters. It can also provide feedback for power measurement, where the VOS adjustment is associated with the actual power level at various locations.

An intelligent power optimization program can be used to calculate the optimum power level for each path (each output of each VOS, and the WSS attenuation, etc.). It can be specific to the particular MD-ROADM node and work with the node controller (110) directly. It can also be a network-wide optimization engine that coordinates the power level among all elements (switching nodes, amplifiers, transponders, etc.) in the network to provide even more complete optimization. It can work with the software-defined networking (SDN) technology, where the optimization engine (with appropriate algorithm, software program) is located in the network controller software, and controls the network hardware (including the MD-ROADM nodes, and the VOS and WSS inside them) through a common interface such as OpenFlow.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

What is claimed is:

1. A reconfigurable optical add/drop multiplexer (ROADM) system, comprising:
a plurality of transponder aggregators;
N input ports and N output ports, each coupled to the transponder aggregators and to a cross-connect module having a variable optical splitter or variable optical coupler (VOS/VOC); and
a controller to set the VOS/VOC into one of a Multicast & Select configuration and a Route & Combine configuration.

2. The system of claim 1, wherein each VOS/VOC is adjusted to send/receive the signal only to/from the output/input port(s) with a useful signal to reduce optical power consumption at other ports.

3. The system of claim 1, wherein the VOS/VOC's configuration can be changed dynamically through the controller.

4. The system of claim 1, comprising wherein selective multicasting is done among various outputs through the Multicast & Select configuration.

5. The system of claim 1, wherein the controller reduces crosstalk by preventing signals reaching the unnecessary ports.

6. The system of claim 1, wherein at a node level, the VOS's are adjusted by the node controller based on the channel arrangement, different power requirements among various cross-connect paths and various add/drop paths, and live power measurement.

7. The system of claim 1, comprising a network level controller to adjust the VOS/VOC across the network to an overall power optimization requirement.

8. The system of claim 7, wherein the network level controller comprises a software defined network controller.

9. The system of claim 1, wherein the Multicast & Select configuration comprises multicasting capability.

10. The system of claim 1, wherein the controller uses the network information to configure the MD-ROADM node hardware (in particular, the VOS's/VOC's) to optimize the power efficiency.

11. A method for operating an optical add/drop multiplexer (ROADM) system, comprising:
providing a plurality of transponder aggregators with N input ports and N output ports, each coupled to the transponder aggregators and to a cross-connect module having a variable optical splitter or variable optical coupler (VOS/VOC); and
setting the VOS/VOC into one of a Multicast & Select configuration and a Route & Combine configuration.

12. The method of claim 11, wherein each VOS/VOC is adjusted to send/receive the signal only to/from the output/input port(s) with a useful signal to reduce optical power consumption at other ports.

13. The method of claim 11, wherein the VOS/VOC's configuration can be changed dynamically through the controller.

14. The method of claim 11, comprising performing selective multicasting among various outputs through the Multicast & Select configuration.

15. The method of claim 11, comprising reducing crosstalk by preventing signals reaching the unnecessary ports.

16. The method of claim 11, comprising controlling at a node level, where the VOS's are adjusted by the node controller based on the channel arrangement, different power requirements among various cross-connect paths and various add/drop paths, and live power measurement.

17. The method of claim 11, comprising adjusting the VOS/VOC across the network to an overall power optimization requirement.

18. The method of claim 17, wherein the network level controller comprises a software defined network controller.

19. The method of claim 11, wherein the Multicast & Select configuration comprises multicasting capability.
